(19) United States
(12) Patent Application Publication
(10) Pub. No.: US 2008/0133255 A1
(43) Pub. Date: Jun. 5, 2008

(54) SELF-SERVICE SLEEPING UNIT

(76) Inventor: Robert D. Schau, New York, NY (US)

Correspondence Address: CARDINAL LAW GROUP, Suite 2000, 1603 Orrington Avenue, Evanston, IL, 60201, US

(21) Appl. No.: 11/565,389

(22) Filed: Nov. 30, 2006

(51) Int. Cl. E04H 1/00; A47G 9/02; G07F 7/00; G06Q 30/00

(52) U.S. Cl. 705/1; 221/1; 52/79.1

(57) ABSTRACT

A method of operating a self-service sleeping chamber includes receiving a payment input, releasing a chamber door lock based on the received payment input, dispensing at least one resting surface cover based on the payment input and releasing the chamber door lock based on a predetermined length of time. A self-service sleeping unit chamber system, includes a housing enclosing a sleeping chamber. The housing includes a chamber access door, the chamber access door including a chamber lock; a linen dispensing device positioned adjacent the housing and a control terminal. The control terminal includes a payment input device and a user interface, wherein the payment input device is operably connected to the linen dispensing device and the chamber lock via the control terminal.

### TECHNICAL FIELD OF THE INVENTION

This invention relates generally to sleeping quarters and more specifically, to self-service sleeping units for travelers and others.

### BACKGROUND OF THE INVENTION

Traveling via airplane and train has become commonplace, with the numbers of travelers increasing dramatically over the last several years. Many passengers have encountered some of the drawbacks of traveling by air and train, namely, delays due to weather, overbooking and cancellations. Another inconvenience is lengthy waits between connecting flights, especially when traveling overseas. Lengthy waits, delays and cancellations leave passengers few if any options for resting until the next train or plane leaves.

One option that may be available to travelers is a hotel. However, hotels are not generally available for short time intervals, are expensive and are often not conveniently located in relation to the airport or train terminal. Additionally, during extensive delays affecting a lot of passengers, available hotel rooms in close proximity to the terminal are quickly secured. This lack of available rooms leaves many passengers with no option other than using available terminal seating.

Another option travelers may have for resting are lounge chairs. However, lounge chairs do not provide privacy or security to the person while the lounge chair is in use. Yet a further problem is that lounge chairs do not provide a flat surface to rest on and, thus, do not allow the user to fully stretch out as one would while sleeping. Another problem with the lounge chairs is cleanliness. Lounge chairs are rarely, if ever, cleaned between users.

Therefore, it would be desirable to provide a self-service sleeping unit that overcomes the aforementioned and other disadvantages.

### SUMMARY OF THE INVENTION

A first aspect according to the invention provides a method of operating a rest chamber includes receiving a payment input, releasing chamber door lock based on the payment input, dispensing at least one resting surface cover based on the payment input and releasing the chamber door lock based on a predetermined length of time.

A second aspect according to the invention provides a self-service sleeping unit chamber system. The system includes a housing enclosing a sleeping chamber, the housing includes a chamber access door and a linen dispensing device. The chamber access door includes a chamber lock. The linen dispensing device is positioned adjacent the housing. The system further includes a control terminal, the control terminal includes a payment input device and a user interface, wherein the payment input device is operably connected to the linen dispensing device and the chamber lock via the control terminal.

A third aspect according to the invention provides a method of operating a rest chamber that includes receiving a payment input, providing an entry access code based on the received payment input and receiving an entry access code input. The method further includes releasing a chamber door lock based on the received entry access code input and dispensing at least one resting surface cover based on the received entry access code input.

The foregoing and other features and advantages of the invention will become further apparent from the following detailed description of the presently preferred embodiments, read in conjunction with the accompanying drawings. The drawings are not drawn to scale. The detailed description and drawings are merely illustrative of the invention, rather than limiting the scope of the invention being defined by the appended claims and equivalents thereof.

### BRIEF DESCRIPTION OF THE DRAWINGS

FIG. 1 is an illustration of a one embodiment of a self-service sleeping unit system in accordance with the present invention;

FIG. 2 is a flow diagram of one embodiment of a method of operating a self-service sleeping system, in accordance with the present invention;

FIG. 3 is a flow diagram of another embodiment of a method of operating a self-service sleeping system, in accordance with the present invention

FIG. 4 is an illustration of another embodiment of a self-service sleeping unit system, in accordance with the present invention;

FIG. 5 is an illustration of another embodiment of a self-service sleeping unit system, in accordance with the present invention; and

FIG. 6 is an illustration of the elevation of the self-service sleeping unit system illustrated in FIG. 5.

Like reference numbers are used throughout the drawings to refer to like elements.

### DESCRIPTION OF THE PRESENTLY PREFERRED EMBODIMENTS

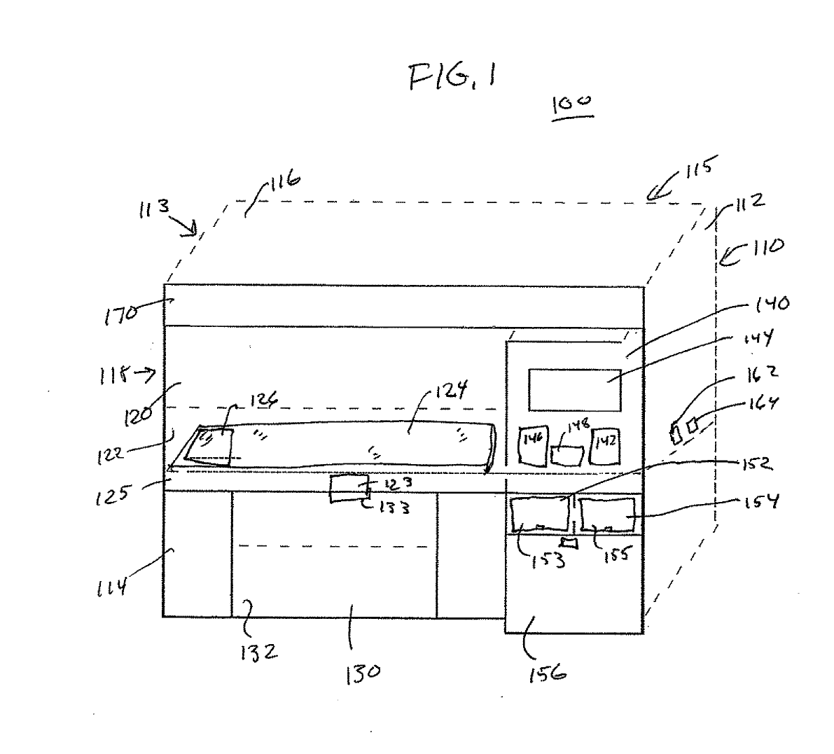

Referring to FIG. 1, self-service sleeping unit system 100 comprises a housing 110 having sidewalls, 112,113, front wall 114, back wall 115, ceiling 116 and floor 117. Housing 110 may be constructed of materials including wood, metal, plastic and combinations thereof. In one embodiment, housing 110 is fabricated of blow-molded plastic. In another embodiment, a housing manufactured of blow-molded plastic defines a plurality of chambers within the housing walls. In one embodiment, these wall chambers are filled with foam. In one embodiment, the foam is fire-retardant. In another embodiment, the foam provides insulation from environmental noise.

Housing 110 encloses a sleeping chamber 120, a storage compartment 130, and a control terminal 140. In one embodiment, housing 110 further encloses a linen dispensing unit 150. In another embodiment, linen dispensing unit 150 is operably connected to housing 110. In yet another embodiment, linen dispensing unit 150 is a freestanding unit operably connected to control terminal 140.

In one embodiment of system 100, housing 110 is divided into an upper portion 118 and a lower portion 119. In one embodiment, the upper portion 118 of housing 110 includes sleeping chamber 120 and the lower portion 119 includes storage compartment 130. A horizontal member 125 separates upper portion 118 and lower portion 119. In one embodiment member 125 provides a platform for supporting a sleeping surface 124.

In one embodiment, sleeping surface 124 comprises a mattress. In various embodiments, the mattress may comprise a coil mattress or a foam mattress. Sleeping surface 124 may comprise a standard sized mattress such as, for example, a single-sized mattress, a twin-sized mattress or a full sized mattress, as are well known in the art. In another embodiment, sleeping surface 124 may have a non-standard size mattress to suit a particular application. Sleeping surface 124 may be any surface suitable for sleeping as are known in the art.

In one embodiment, sleeping chamber 120 is sized to accommodate a single person. In another embodiment, sleeping chamber 120 is sized to accommodate more than one person. In one embodiment, sleeping chamber 120 may include a vertical dimension sufficient to allow the occupant to sit upon the sleeping surface 124. In another embodiment, sleeping surface 124 also includes a pillow 126.

Sleeping chamber 120 further includes a door 122. Door 122 may be any door type suitable for providing privacy and security. Door 122 may comprise, for example, a folding door, an accordion style door, a rolling door, a bi-fold door or a hinged door. Door 122 includes a security lock 123. In one embodiment, lock 123 comprises an electronically activated lock. In one embodiment, lock 123 includes or is operably connected to a numerical or alpha-numeric keypad for input of an access code.

Storage compartment 130 comprises a walled chamber 124 that includes an access door 132 and a lock 133. In one embodiment, storage compartment 130 is located below the sleeping chamber 120. Storage compartment 130 is sized to accommodate personal belongs of the occupant. The size of storage compartment 130 may vary depending on the available space and/or the specific application of system 100. In one embodiment, storage compartment 130 is sized to accommodate one to several pieces of luggage. Access door 132

comprises a door that will provide security to the belongings locked inside. Door 132 may be the same as or similar to door 122 described above, albeit on a smaller scale. In one embodiment, lock 133 comprises an electronically activated lock. In one embodiment, lock 133 is activated by an entry code provided to the occupant, described in more detail below. In one embodiment, system 100 includes a dual lock that locks both sleeping chamber door 122 and storage compartment door 132.

System 100 further includes control terminal 140. Control terminal 140 comprises an interface 144 for use by a user to access system 100. Control terminal 120 comprises hardware and software for providing a method of accessing the sleeping unit. In one embodiment, interface 144 comprises a graphical user interface (GUI) that displays the instructions and other information a user may need to access the sleeping unit. In one embodiment, the graphical user interface comprises a touch screen for displaying and activating the various components and instructions for accessing the sleeping unit. In one embodiment, GUI 144 displays instructions for payment. In one embodiment, control terminal 140 includes a device 142 for accepting payment. In one embodiment, the payment device 142 comprises a credit card payment system. In this embodiment, the payment device 142 includes a credit card reader. In one embodiment, the payment device accepts both credit cards and debit cards. In an embodiment that accepts debit cards, the GUI provides a keypad input device for receiving the occupants personal identification number (PIN). In another embodiment, payment device 142 includes a device for accepting currency. In one embodiment, control terminal 140 includes a device 148 for providing a receipt. In one embodiment, receipt device 148 comprises a receipt printer operably connected to the payment device 142 and control terminal 140. In another embodiment, control terminal 140 includes a payment device 142 that receives payment via smart cards or other short range wireless devices.

Control terminal 140 also includes controls 146 for providing linens through linen dispensing system 150. In one embodiment, controls 146 for dispensing linens via linen dispensing system 150 are activated via GUI 144. Linen dispensing system 150 includes compartments 152 and 154 for storing clean pillowcases and clean surface covers (sheets). In one embodiment, linen dispensing also includes a linen disposal compartment 156 for disposing of used linens. In one embodiment, compartments 152 and 154 include an access door 153,155, respectively, for use by the occupant for accessing a clean set of linens. In one embodiment, access doors 153 and 155 remain locked until payment is received. In one embodiment, linen dispensing system 150 allows the user access to only one set of linens. In another embodiment, linen dispensing system 150 comprises a dispensing system that automatically dispenses a clean set of linens to the occupant upon receipt of payment. In this embodiment, the linens may drop into a bin or other compartment that is accessible to the occupant. In another embodiment, the linens may drop onto or otherwise be placed on the sleeping surface inside the sleeping compartment upon receipt of payment.

Self-service sleeping unit system 100 may further include a marquee 170. Marquee 170 may include lights, signage and/or a vacancy indicator. In another embodiment, system 100 further includes electrical outlets 162 for use by the occupant while inside the sleeping chamber. In another or the same embodiment, system 100 includes a computer terminal Internet access hook-up 164 for use by the occupant. System 100 may also include safety features such as, for example, lights, alarm, fire extinguisher etc. System 100 may also include reading lights and fans for the comfort of the occupant. The inclusion and location of these various components (lights, fans, alarm, outlets, etc.) depends on the size of the compartment and the application of the sleeping system. For

example, in a low cost application the system may include a reading light but not electrical or computer outlets. Those with skill in the art will recognize that there are numerous combinations of components the sleeping system may contain.

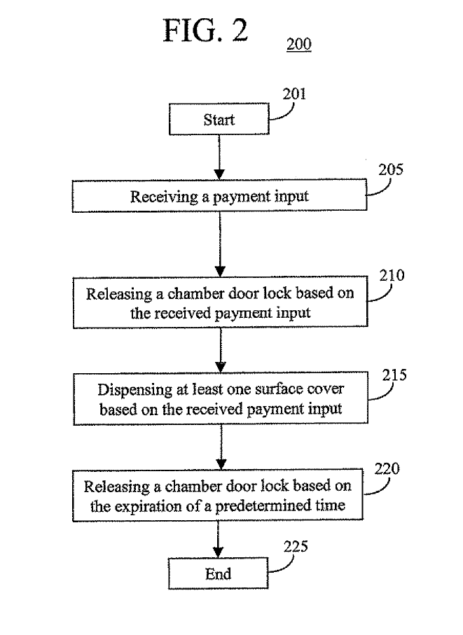

Another aspect of the present invention is a method 200 for operating a self-service sleeping unit. FIG. 2 is a flow diagram of one embodiment of a method 200 in accordance with the present invention. In one embodiment, method 200 is implemented using system 100 described above. Method 200 begins at step 201.

At step 205, a payment input is received at control terminal 140. In one embodiment, the payment input comprises a credit or debit card input. In another embodiment, the payment input comprises receiving currency. In practice, an occupant inputs the desired method of payment at control terminal 140 using GUI 144. In one embodiment, payment input includes credit card verification. In another embodiment, payment input includes receipt of a PIN corresponding to the debit card used for payment. In one embodiment, payment input may include receiving a time input corresponding to the length of time the occupant wants to occupy the sleeping chamber. In one embodiment, the amount of payment received is proportional to the amount of time the sleeping chamber is to be occupied.

At step 210, the door to the sleeping chamber is released based on the received payment input. In one embodiment, lock 123 is an electronic security lock operably connected to control terminal 140. Upon receipt of the payment input, a signal is sent to the electronic lock to unlock the door, thereby providing access to the sleeping chamber. In another embodiment, lock 133 to the storage compartment is also unlocked based on the received payment input in order to allow access to the storage compartment. In another embodiment, the electronic lock is a dual lock that receives a signal to unlock both the sleeping chamber door and the storage compartment door based on the received signal.

At step 215, at least one surface cover is dispensed based on the received payment input. In one embodiment a set of linens is provided to the sleeping chamber based on the received payment input. In another embodiment, a linen dispenser door opens to allow the occupant to retrieve a set of linens from the linen storage chamber.

At step 220, the chamber door lock is released based on the expiration of a predetermined time. The predetermined time may be based on the amount of payment received. In another embodiment, the predetermined time is based on a received input from the user as to when the occupant wants to exit the chamber. In this embodiment, the release of the lock may act as an alarm clock for the user. Method 200 ends at 225. Those with skill in the art will recognize that the performance of the order of steps for method 200 may vary from the order listed and described without departing from the scope of the invention.

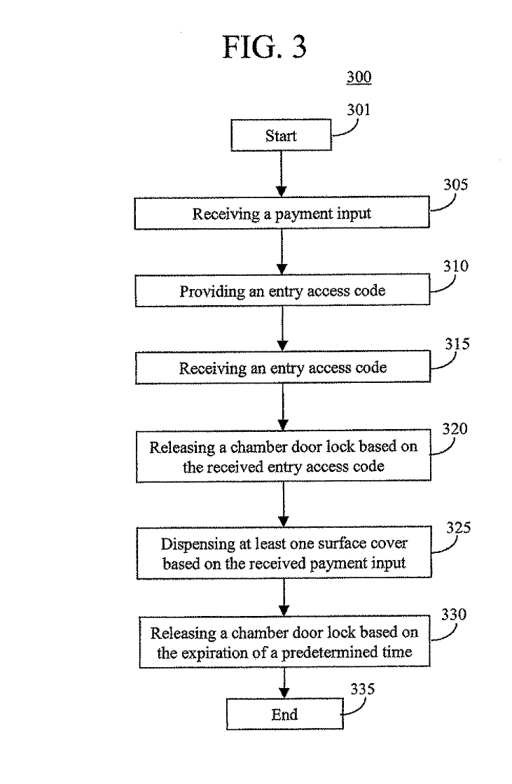

FIG. 3 is a flow diagram of another embodiment of a method 300 for operating a self-service sleeping unit in accordance with the present invention. In one embodiment, method 300 is implemented using system 100 described above. Method 300 begins at step 301.

At step 305, a payment input is received at control terminal 140. In one embodiment, step 305 is implemented as described above for step 205. At step 310, an entry access code is provided based on the received payment input. In one embodiment, the graphical user interface displays an access code to the occupant. In another embodiment, the access code will be printed on a payment receipt provided to the occupant. In one embodiment, the entry access code comprises a numerical code. In another embodiment, the access code comprises an alphanumeric code.

At step 315, the entry access code is received. In one embodiment, the entry access code is received from a keypad operably connected to the lock. In practice, the user will enter the provided entry access code via the keypad. Then, at step 320, based on the received entry access code the chamber door lock is released to allow access to the sleeping chamber. In another embodiment, the lock to the storage compartment is also unlocked based on the received entry access code in order to allow access to the storage compartment. In another embodiment, the electronic lock is a dual lock that receives a signal to unlock both the sleeping chamber door and the storage compartment door based on the received signal.

At step 325, at least one surface cover is dispensed based on the received entry access code. In one embodiment a set of linens is provided to the sleeping chamber based on the received payment input. In another embodiment, a linen dispenser door opens to allow the occupant to retrieve a set of linens from the linen storage chamber.

At step 330, the chamber door lock is released based on the expiration of a predetermined time. The predetermined time may be based on the amount of payment received. In another embodiment, the predetermined time is based on a received input from the user as to when the occupant wants to exit the chamber. In this embodiment, the release of the lock may act as an alarm clock for the user. Method 300 ends at 335. Those with skill in the art will recognize that the performance of the order of steps for method 300 may vary from the order listed and described without departing from the scope of the invention.

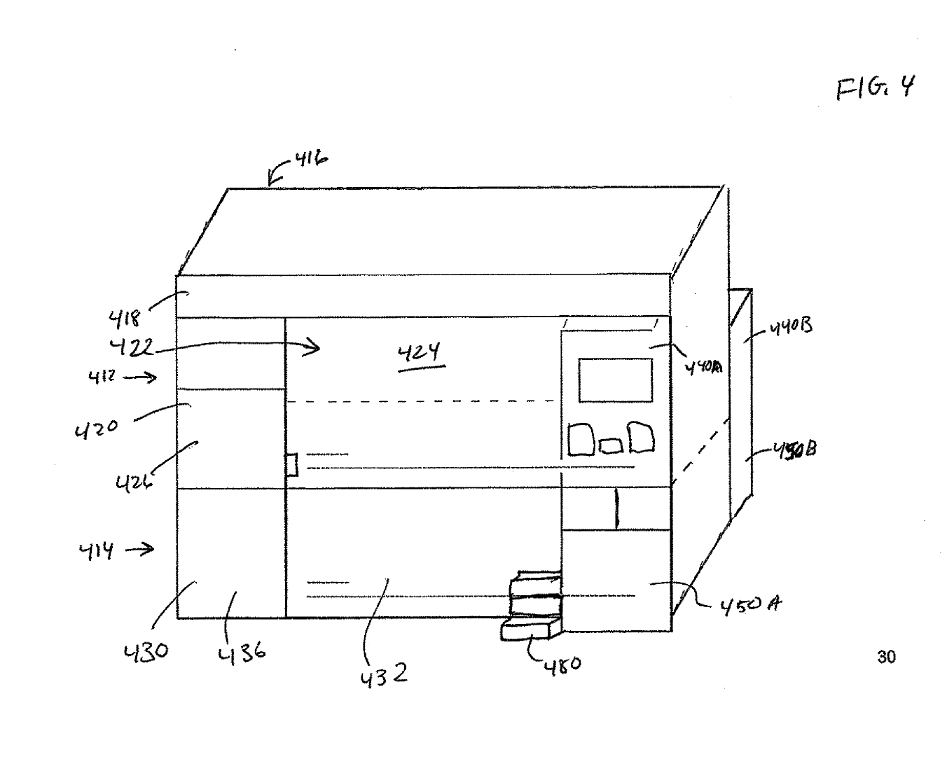

FIG. 4 illustrates another embodiment of a self-service sleeping unit system 400, in accordance with the present invention. System 400 comprises a stackable sleeping structure housing 410 that includes a first sleeping unit 420 on an upper level 412 and a second sleeping unit 430 on a lower level 414. The components of each sleeping unit are similar to or the same as those described above for system 100. However, in system 400, the storage compartment and corresponding sleeping chamber are disposed on the same level. As is illustrated, upper level 412 includes sleeping chamber 422 and storage compartment 426 and lower level 414 includes sleeping chamber 432 and storage compartment 436.

System 400 can be further characterized as having a front 418 and a back 416. In system 400 the access door 424 for the first sleeping unit 420 is on the front 418 and the access door (not shown) for the second sleeping unit is on the back 416. Having the access doors in this manner provides more privacy than if the doors were on the same side of the system. Though the access doors may be on the same side without departing from the spirit and scope of the invention.

In system 400, each sleeping unit 420 and 430 includes a corresponding control terminal 440A and 440B, respectively. Control terminals 440A and 440B are the same as or similar to control terminal 140 described above. In one embodiment, control terminal 440A is on the front 418 of housing 410 adjacent to access door 424. Control terminal 440B is on the back of housing 410, adjacent to the access door for sleeping unit 430.

System 400 also includes linen dispensing systems 450A and 450B. Linen dispensing systems 450A and 450B are the same as or similar to linen dispensing system 150. In one embodiment, linen dispensing system 450A is located on the front 418 of housing 410 and linen dispensing systems 450B is located on the back 416 of housing 410.

In one embodiment, system 400 further includes a stair portion 480 for access to the upper stacked unit 420. Stair portion 480 may be formed integrally with housing 410 or separate from housing 410. In another embodiment, stair portion 480 is separate from housing 410.

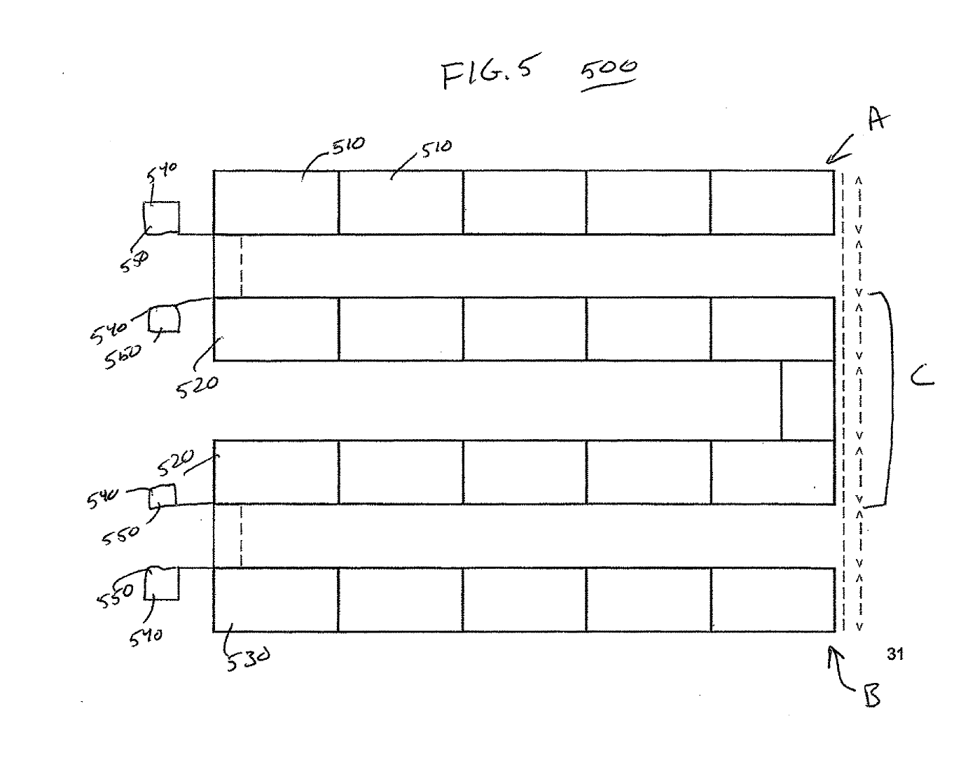

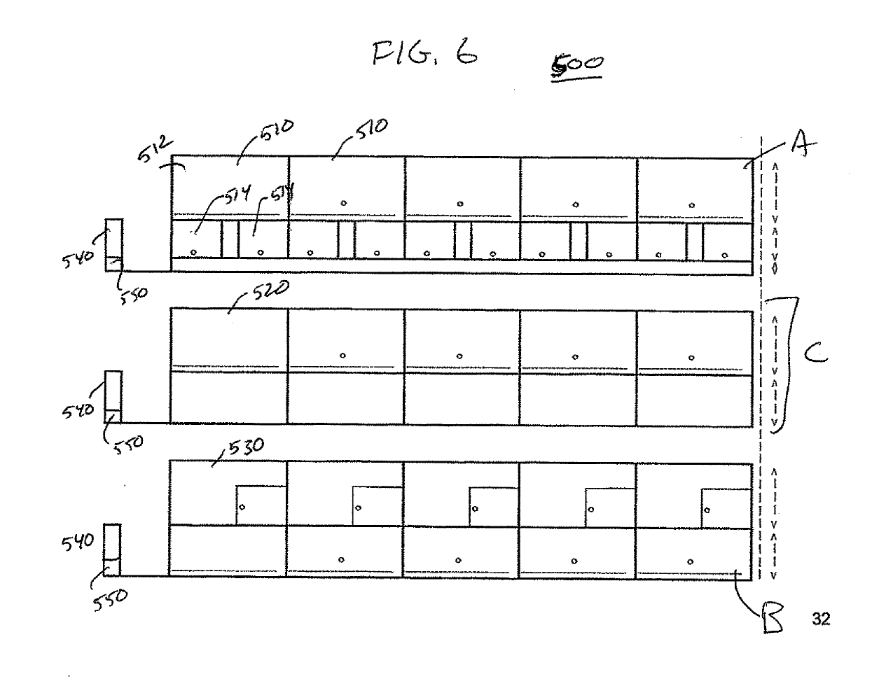

Those with skill in the art will recognize that the number and arrangement of sleeping units may vary depending on the application. For example, where a large space is available for placement of the self-service sleeping units, the space may contain several stacked sleeping units and or several single sleeping units. FIGS. 5 and 6 illustrate one such application. FIG. 5 illustrates one example of a floor plan where a plurality of sleeping units are disposed in rows within the available space. The arrangement of the units is such as to provide the least amount of congestion and the most amount of privacy. Thus, in one embodiment, the entry access doors alternate between the top and bottom of the units and the front and back. In other applications, the arrangement of the number of sleeping units may vary. As an example, sleeping units 510, 530 on the exterior walls A and B of the floor space may comprise single sleeping units such as system 100 described above and illustrated in FIG. 1. At the same time, those sleeping units 520 located within the center portion C of the floor plan may comprise stackable units such as the stackable system 400 described above and illustrated in FIG. 4.

In one embodiment of system 500, each row of sleeping units includes a control terminal 540. Control terminal 540 may be the same as or similar to control terminal 140 described above and illustrated in FIG. 1. In another or the same embodiment, each row of sleeping units includes a linen dispensing system 550. Linen dispensing system 550 may be the same as or similar to linen dispensing system 150 described above and illustrated in FIG. 1.

Those with skill in the art will recognize that the arrangement of the various components may vary from those described above for FIGS. 1 and 2. For example, FIG. 6 illustrates sleeping units 510 having a single sleeping compartment and two storage compartments 514. In another embodiments, the sleeping unit may include more than two storage compartments. For example, in one embodiment, the sleeping unit includes an upper storage compartment and two lower storage compartments.

While the embodiments of the invention disclosed herein are presently considered to be preferred, various changes and modifications can be made without departing from the spirit and scope of the invention. The scope of the invention is indicated in the appended claims, and all changes and modifications that come within the meaning and range of equivalents are intended to be embraced therein.

1. A method of operating a self-service sleeping chamber, the method comprising:
receiving a payment input;
releasing a chamber door lock based on the received payment input; and
dispensing at least one resting surface cover based on the received payment input.

2. The method of claim 1 further comprising:
releasing the chamber door based on an expiration of a predetermined time.

3. The method of claim 1 further comprising:
releasing a storage compartment lock based on the received payment input.

4. The method of claim 3 further comprising:
releasing the storage compartment lock based on an expiration of a predetermined time.

5. A self-service sleeping unit chamber system, comprising:
a housing enclosing a sleeping chamber, the housing including a chamber access door, the chamber access door including a chamber lock;
a linen dispensing device positioned adjacent the housing;
a control terminal, the control terminal including a payment input device and a user interface,
wherein the payment input device is operably connected to the linen dispensing device and the chamber lock via the control terminal.

6. The system of claim 5 wherein the payment input device includes an entry code providing device that provides an entry code based on payment input.

7. The system of claim 5 wherein the housing comprises a modular unit comprising a plurality of sleeping units.

8. The system of claim 7 wherein the modular unit includes a first sleeping unit and a second sleeping unit, the first sleeping unit positioned above the second sleeping unit.

9. The system of claim 8 wherein the modular unit includes a stair portion formed therein for access to a sleeping chamber of the first sleeping unit.

10. The system of claim 5 wherein the payment input device comprises a credit card entry system for receiving payment via credit cards and debit cards.

11. The system of claim 5 wherein the chamber lock comprises an electronic locking mechanism operably connected to the control terminal.

12. The system of claim 11 wherein the electronic locking mechanism further comprises a keypad.

13. The system of claim 12 wherein the linen dispensing device is operably connected to the electronic locking mechanism via the terminal controller.

14. The system of claim 5 wherein the linen dispensing device is configured to dispense a single set of linens.

15. The system of claim 5 further comprising at least one storage compartment, the storage compartment having a storage compartment access door and a storage compartment lock.

16. The system of claim 15 wherein the storage compartment lock is operably connected to the control terminal.

17. A method of operating a rest chamber, the method comprising:
receiving a payment input;
providing an entry access code based on the received payment input;
receiving an entry access code input;
releasing a chamber door lock based on the received entry access code input; and
dispensing at least one resting surface cover based on the received entry access code input.

18. The method of claim 17 further comprising:
releasing the chamber door based on an expiration of a predetermined time.

19. The method of claim 17 further comprising:
releasing a storage compartment door lock based on the received entry access code input.
